(19) United States
(12) Patent Application Publication
(10) Pub. No.: US 2018/0218836 A1
(43) Pub. Date: Aug. 2, 2018

(54) METHOD OF MAKING A MULTI-LAYER MAGNETO-DIELECTRIC MATERIAL

(71) Applicant: Rogers Corporation, Chandler, AZ (US)

(72) Inventors: Eui Kyoon Kim, Acton, MA (US); Michael White, Pomfret Center, CT (US); Murali Sethumadhavan, Acton, MA (US); Karl Edward Sprentall, Medford, MA (US)

(21) Appl. No.: 15/882,397

(22) Filed: Jan. 29, 2018

Related U.S. Application Data
(60) Provisional application No. 62/451,865, filed on Jan. 30, 2017.

(51) Int. Cl. H01F 41/14; H01F 10/14; H01F 10/30; B32B 18/00; B32B 37/06; B32B 38/00

(52) U.S. Cl. CPC H01F 41/14; H01F 10/14; H01F 10/30; H01Q 9/0407; B32B 37/06; B32B 38/0004; B32B 38/0008; B32B 18/00

(57) ABSTRACT

In an embodiment, a method of forming a magneto-dielectric material comprises roll coating a ferromagnetic material onto a dielectric layer comprising a dielectric material by continuously moving the dielectric layer through a ferromagnetic coating zone to form a coated sheet; forming a plurality of sheets from the coated sheet; forming a layered stack of the plurality of sheets; laminating the layered stack to form the magneto-dielectric material having a plurality of alternating ferromagnetic layers and dielectric layers. In another embodiment, a method of forming a magneto-dielectric material comprises drum roll coating a ferromagnetic material and a dielectric material onto a drum roll to form the magneto-dielectric material having a plurality of alternating ferromagnetic layers and dielectric layers.

### CROSS-REFERENCE TO RELATED APPLICATION

This application claims the benefit of U.S. Provisional Patent Application Ser. No. 62/245,865 filed Jan. 30, 2017. The related application is incorporated herein in its entirety by reference.

### BACKGROUND

The present disclosure relates generally to a method of making a magneto-dielectric material, particularly to a multi-layer magneto-dielectric material, and more particularly to a multi-layer magneto-dielectric thin film material.

Multi-layer dielectric-magnetic structures have the benefit of exploiting shape anisotropy to produce higher ferromagnetic resonance frequencies, and exploiting favorable mix rules for dielectric and magnetic materials to produce a laminate having a low z-axis permittivity and high x-y plane permeability, which is ideal for patch derived antenna structures. However, existing laminates unfavorably suffer from high magnetic loss, high dielectric loss, and/or low permeability due to a high ratio of dielectric to magnetic material volumes.

While prior publications have disclosed the concept of reducing the thickness of the dielectric insulating material as a method of increasing impedance (the square root of the ratio of effective permeability to permittivity), these publications have lacked the information to enable the reduction of this concept to practice. Specifically, the need to maintain the integrity of the dielectric layer during the high temperature deposition of the ferromagnetic material has not been addressed in sufficient detail to enable the reduction to practice of these structures with thin dielectric materials.

A second limitation, which has not been addressed, is the need for an antenna material that can withstand transient voltages seen by an antenna substrate. In a practical application, transient voltages caused by a mismatch between the antenna and a power source, rapid changes in current, or electrostatic discharge, can cause the degradation of the insulating layer between the ferromagnetic materials. This degradation can lead to two primary failure modes. In a first failure mode, in the event of a dielectric breakdown, where the ferromagnetic layer is sufficiently thick (greater than 1/10^{th} the polymer/dielectric layer thickness), a shorting between ferromagnetic layers can occur. This shorting between layers can result in a shift of the effective permeability or permittivity, changing the resonant frequency of an antenna, reducing the radiation efficiency, and/or further degrading the match between the antenna and the power source, leading to an unstable antenna substrate whose properties continue to degrade with time. In a second failure mode, when the ratio between polymer thickness to metal thickness is sufficiently high (approximately greater than 10:1), typically no shorting between the ferromagnetic layers will occur. In these two types of failure modes, the dielectric constant of the multi-layer structure will shift, resulting in a corresponding shift in antenna resonant frequency.

While existing multi-layer magneto-dielectric materials may be suitable for their intended purpose, the art relating to multi-layer magneto-dielectric materials would be advanced with a multi-layer magneto-dielectric material that overcomes at least some of the unfavorable limitations of existing laminates.

### BRIEF SUMMARY

Disclosed herein is a method of forming a magneto-dielectric material and the magneto-dielectric material made therefrom.

A method of forming a magneto-dielectric material comprises roll coating a ferromagnetic material onto a dielectric layer comprising a dielectric material by continuously moving the dielectric layer through a ferromagnetic coating zone to form a coated sheet comprising a ferromagnetic layer disposed on the dielectric layer, wherein the dielectric layer travels a path from a first roll through the ferromagnetic coating zone to a second roll; forming a plurality of sheets from the coated sheet; forming a layered stack of the plurality of sheets; laminating the layered stack to form the magneto-dielectric material having a plurality of alternating ferromagnetic layers and dielectric layers, wherein an uppermost layer and a lowermost layer comprise an outer layer dielectric material.

A method of forming a magneto-dielectric material comprises drum roll coating a ferromagnetic material and a dielectric material onto a drum roll, wherein a ferromagnetic coating zone and a dielectric coating zone are disposed radially in a position around the drum roll, and wherein the ferromagnetic coating zone deposits the ferromagnetic material and the dielectric coating zone deposits the dielectric material to form the magneto-dielectric material having a plurality of alternating ferromagnetic layers and dielectric layers; wherein an uppermost layer and a lowermost layer of the magneto-dielectric material comprise an outer layer dielectric material.

The above described and other features are exemplified by the following figures, detailed description, and claims.

### BRIEF DESCRIPTION OF THE DRAWINGS

The figures are exemplary embodiments, wherein the like elements are numbered alike.

FIG. 1 depicts an illustrative perspective view of an embodiment of a magneto-dielectric material;

FIG. 2 depicts an illustrative embodiment of a roll-to-roll coater;

FIG. 3 depicts an illustrative embodiment of a drum roll coater; and

FIG. 4 depicts an illustrative perspective view of an embodiment of an apparatus comprising the magneto-dielectric material.

### DETAILED DESCRIPTION

As hand held wireless devices have been gaining attention, there is a continuing need for smaller and more complex antennas, but fabrication methods for such materials have proven difficult. An improved method of forming a magneto-dielectric material was discovered. The method comprises roll coating a ferromagnetic material onto a dielectric layer by continuously moving the dielectric layer comprising a dielectric material through a ferromagnetic coating zone to form a coated sheet comprising a ferromagnetic layer disposed on the dielectric layer; wherein the dielectric layer travels a path from a first roll through the ferromagnetic coating zone to a second roll; or drum roll coating a ferromagnetic material and a dielectric material onto a drum roll; wherein a ferromagnetic coating zone and a dielectric coating zone are disposed radially in a position around the drum roll; and wherein the ferromagnetic coating zone deposits the ferromagnetic material and the dielectric coating zone deposits the dielectric material to form the magneto-dielectric material having a plurality of alternating ferromagnetic layers and dielectric layers. The magneto-dielectric material comprises a plurality of alternating ferromagnetic layers and dielectric layers; wherein an uppermost layer and a lowermost layer comprise an outer layer dielectric material.

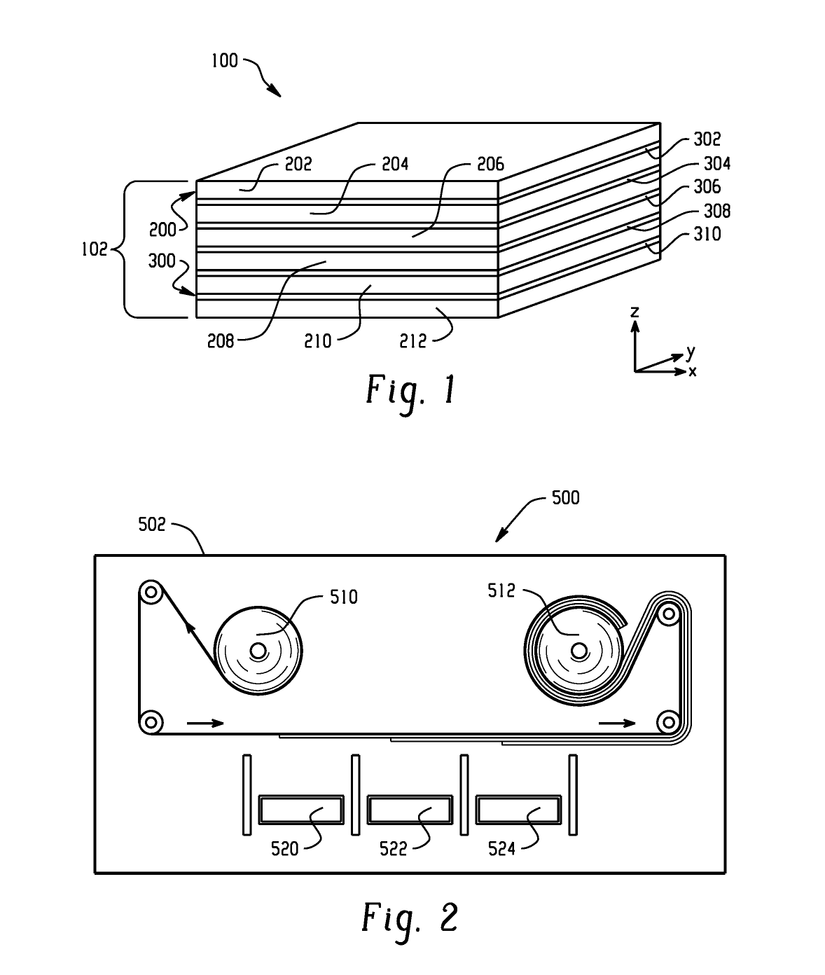

For example, FIG. 1 illustrates that the magneto-dielectric material includes a plurality of layers 102 in conforming direct contact with respective adjacent layers that alternate between dielectric material 200 and ferromagnetic material 300 forming a plurality of dielectric layers 202, 204, 206, 208, 210, 212 in alternating arrangement with a plurality of ferromagnetic material layers 302, 304, 306, 308, 310. The outermost layers of the plurality of layers are dielectric layers 212 and 202 of dielectric material 200. The plurality of layers 102 is arranged parallel with an x-y plane in an orthogonal x-y-z coordinate system, and the overall thickness of the plurality of layers 102 is in the z-direction. The plurality of dielectric layers can occupy 0.1 to 99 volume percent (vol %), or 0.1 to 50 vol %, or 50 to 90 vol %, or 90 to 99 vol %, or 5 to 55 vol % of the total volume of the plurality of layers.

While the magneto-dielectric material 100 of FIG. 1 depicts individual ones of the plurality of layers 102 having certain visual dimensions with respect to itself and in relation to another layer, it will be appreciated that this is for illustration purposes only and is not intended to limit the scope of the disclosure disclosed herein, and the scale of the plurality of layers 102 is depicted in an exaggerated manner. While only five layers of ferromagnetic material layers 302 to 310 are described herein and depicted in FIG. 1, it will be appreciated that the scope of the disclosure is not so limited and encompasses any number of layers, more or less than five, suitable for a purpose disclosed herein and falling within the ambit of the claims provided herewith. Likewise, while only six layers of dielectric material layers 202-212 are described herein and depicted in FIG. 1, it will be appreciated that the scope of the disclosure is not so limited and encompasses any number of layers, more or less than six, suitable for a purpose disclosed herein and falling within the ambit of the claims provided herewith. For example, the total number of layers 102 can be 19 to 10,001. Any range of layers between 19 and 10,001 layers is contemplated without the unnecessary listing of each and every range contemplated.

The magneto-dielectric can be operable over an operating frequency range greater than or equal to a defined minimum frequency and less than or equal to a defined maximum frequency. The defined minimum frequency can be given by, (defined minimum frequency)=(defined maximum frequency)/25. The defined maximum frequency can be 7 gigahertz (GHz). The operating frequency range can be 100 megahertz (MHz) to 10 GHz, or 1 to 10 GHz, or 100 MHz to 5 GHz.

The plurality of layers can have an overall thickness of less than or equal to one wavelength of the defined minimum frequency that propagates in the plurality of layers. The wavelength in the plurality of layers is given by:

λ=c/[f*sqrt(ε₀*εᵣ*μ₀*μᵣ)];

where: c is the speed of light in a vacuum in meters per second; f is the defined minimum frequency in Hertz; ε₀ is the permittivity of a vacuum in Farads/meter; εᵣ is the relative permittivity of the plurality of layers in the z-direction; μ₀ is the permeability of a vacuum in Henrys/meter; and μᵣ is the relative permeability of the plurality of layers in the x-y plane. The plurality of layers 102 has an overall electric loss tangent (tanδₑ), an overall magnetic loss tangent (tanδₘ), and an overall quality factor (Q) defined by (1/((tanδₑ)+(tanδₘ)), wherein the defined maximum frequency is defined by a frequency at which Q equals 20, or more specifically, falls below 20. The overall quality factor Q can be determined according to a standardized Nicolson-Roth-Weir (NRW) method, see NIST (National Institute of Standards and Technology) Technical Note 1536, “Measuring the Permittivity and Permeability of Lossy Materials: Solids, Liquids, Metals, Building Materials, and Negative-Index Materials”, James Baker Jarvis et al., February 2005, CODEN: NTNOEF, pp. 66-74, for example. The NRW method provides calculations for ε′ and ε″ (complex relative permittivity components), and for μ′ and μ′ (complex relative permeability components). The loss tangents μ″/μ′ (tanδₘ) and ε″/ε′ (tanδₑ) can be calculated from those results. The quality factor Q is the inverse of the sum of the loss tangents. The overall thickness can be 0.1 to 3 millimeters.

The magneto-dielectric material can be formed by roll coating, specifically by roll-to-roll coating or by drum roll coating. In roll-to-roll coating, a ferromagnetic material is coated onto a dielectric layer by continuously moving the dielectric layer comprising a dielectric material through one or more ferromagnetic coating zones to form a coated sheet; where the ferromagnetic layer is disposed on the dielectric layer. In the roll-to-roll coater, the dielectric layer travels along a path from a first roll through the ferromagnetic coating zone to a second roll. The ferromagnetic coating zone can be located on one or both sides of the dielectric layer. The dielectric layer can travel at a linear speed of 150 to 600 centimeters per minute (cm/min), or 200 to 500 cm/min

The coating in the ferromagnetic coating zone can comprise coating a coating composition by, for example, spray coating, sputter coating (including radio frequency (RF) sputtering, direct current (DC) sputtering, magnetron sputtering, and ion beam sputtering), evaporation (including electron beam evaporation and thermal evaporation), chemical vapor deposition, plasma-enhanced chemical vapor deposition (PECVD), and the like.

The method can further comprise plasma treating the dielectric layer in one or more plasma zones located upstream of the ferromagnetic coating zone. As used herein, upstream refers to a location located prior to the specified location along a path of travel. For example, along the path of travel of the dielectric layer, the plasma zone located upstream of the ferromagnetic zone would result in the dielectric layer first being plasma treated and then being coated with the ferromagnetic material. The plasma zone can be located on one or both sides of the dielectric layer. The plasma treatment can occur at a power density of 0.02 to 0.2 W/cm² and a total pressure of N₂ and Ar of 0.1 to 2 Pa.

The method can further comprise coating one or more additional dielectric materials. For example, an additional dielectric material can be coated onto the ferromagnetic layer in one or more dielectric coating zones located downstream of the ferromagnetic coating zone. As used herein, downstream refers to a location located after the specified location along a path of travel. For example, along the path of travel of the dielectric layer, the dielectric coating zone located downstream of the ferromagnetic zone would result in the dielectric layer first being coated with the ferromagnetic material and then being coated with the additional dielectric material. A plasma zone can be located in between the ferromagnetic coating zone and the dielectric coating zone. The dielectric coating zone can be located on one or both sides of the dielectric layer.

The coating in the dielectric coating zone can comprise coating a coating composition by, for example, spray coating, sputter coating (including radio frequency (RF) sputtering, direct current (DC) sputtering, magnetron sputtering, and ion beam sputtering), evaporation (including electron beam evaporation and thermal evaporation), chemical vapor deposition (including plasma-enhanced chemical vapor deposition (PECVD)), roll over knife coating, reverse roll coating, and the like. The coating composition can comprise a curable composition, for example, that can be thermally cured, electron beam cured, or cured via ultraviolet light.

The additional dielectric material can be the same material or a different material, can have the same or different dielectric constants, and can have the same or different thickness as the dielectric material. For example, the dielectric material and the additional dielectric material can both comprise a fluorinated polymer such as polytetrafluoroethylene (PTFE). Conversely, the dielectric material can comprise, for example, a fluorinated polymer such as PTFE or a poly(ether ketone) such as poly(ether ether ketone) (PEEK) and the additional dielectric material can comprise, for example, a polyimide or a ceramic such as SiO₂. The SiO₂ can be amorphous SiO₂. One or both of the dielectric material and the additional dielectric material can comprise poly(ethylene terephthalate), polypropylene, poly(ether ether ketone), a perfluoroalkoxy, or a combination comprising at least one of the foregoing.

The deposition of one or more of the respective layers can be continuous. The deposition of one or more of the respective layers can continuously deposit a layer of a specified thickness. The deposition of one or more of the respective layers can continuously deposit a layer having a thickness that can vary with time, for example, in a step-wise manner. Alternatively, or in addition to, the linear speed of the dielectric layer can be varied to result in a coating with varied thickness.

FIG. 2 is an illustrative example of an embodiment of roll-to-roll coater 500. In roll-to-roll coater 500, the dielectric layer is wrapped around first roll 510. First roll 510 rotates in a clockwise direction to release the dielectric layer. Along the path of travel of the dielectric layer, as illustrated by the arrows, plasma zone 520 is located upstream of ferromagnetic zone 522, which is located upstream of dielectric coating zone 524. After passing through dielectric coating zone 524, the dielectric layer is wrapped on second roll 512 that is also rotating in a clockwise direction. Although FIG. 2 illustrates only 1 of each zone is present, it is appreciated, that more than one of each zone can be present. For example, it is noted that a second ferromagnetic coating zone can be present. The entire set-up is located in vacuum chamber 502.

After the sheet is coated with at least a ferromagnetic material, the coated sheet can be formed, for example, by cutting the coated sheet, into a plurality of coated sheets. The plurality of coated sheets can be formed into any shape or size depending on the application. The plurality of coated sheets can be layered upon one another to form a layered stack.

The sheets of the layered stack can be layered in a variety of ways. For example, if the ferromagnetic zone and optional dielectric coating zone are located on only one side of the dielectric layer, then all of the sheets can be stacked such that all of the ferromagnetic layers are directed in the same direction relative to the dielectric material. Alternatively, the sheets can be arranged such that alternating sheets in the layered stack have the ferromagnetic layer pointed in the opposite direction relative to the dielectric layer (for example, sheet 1 has the ferromagnetic layer up, sheet 2 has the ferromagnetic layer down, etc.). If a dielectric coating zone is present, the layered stack can comprise alternating layers of the dielectric material and the deposited dielectric material with the ferromagnetic layers disposed in between each of the dielectric layers and the deposited dielectric layers.

The layered stack can further comprise a plurality of thin dielectric films comprising a thin film dielectric material located in between layers of the plurality of sheets. For example, the layered stack can comprise alternating layers of the coated sheets and the thin dielectric films. The thin film dielectric material can comprise the same or different material as the dielectric material. For example, the dielectric material can comprise a fluorinated polymer such as PTFE or a poly(ether ketone) such as PEEK and the thin film dielectric material can comprise, for example, a polyester (such as polyethylene terephthalate), a polyolefin (such as polyethylene, polypropylene, polystyrene, and the like), or a combination comprising at least one of the foregoing. The thin film dielectric can have any suitable thickness, such as a thickness of 0.1 to 50 micrometers, or 2 to 10 micrometers, or 2 to 4 micrometers.

The layered stack can then be laminated to form the magneto-dielectric material, to result in the magneto-dielectric material comprising a plurality of alternating ferromagnetic layers and dielectric layers, where an uppermost layer and a lowermost layer comprise an outer layer dielectric material, where the outer layer dielectric material can be the same or different as the dielectric material. The uppermost layer and the lowermost layer can each independently have a uniform thickness. As used herein, a uniform thickness refers to a layer thickness that is within 5%, or within 1% of an average thickness at all location in the respective layer.

The laminating can occur at a temperature of 150 to 400 degrees Celsius (° C.) and a pressure of 0.3 to 9 megapascal (MPa), or 1 to 7 MPa, or 3 to 5 MPa.

In drum roll coating, a ferromagnetic coating zone and a dielectric coating zone are disposed radially in a position around a rotating drum roll, where the ferromagnetic coating zone deposits the ferromagnetic material and the dielectric coating zone deposits the dielectric material to form the magneto-dielectric material having a plurality of alternating ferromagnetic layers and dielectric layers.

Two or more ferromagnetic coating zones and two or more dielectric coating zones can be disposed radially in a position around the drum roll. For example, the method of drum roll coating can comprise depositing an additional ferromagnetic material in an additional ferromagnetic coating zone and an additional dielectric material in an additional dielectric material coating zone; wherein the path of travel of a location on the drum roll comprises passing sequentially through the dielectric coating zone, the ferromagnetic coating zone, the additional dielectric coating zone, and the additional ferromagnetic coating zone. The ferromagnetic material and the additional ferromagnetic material can be the same or different. For example, the dielectric material and the additional dielectric material can both comprise a fluorinated polymer such as PTFE. Conversely, the dielectric material can comprise, for example, a fluorinated polymer such as PTFE or a poly(ether ketone) such as PEEK and the additional dielectric material can comprise, for example, a polyimide or a ceramic such as amorphous SiO₂. The additional dielectric material can comprise a polyimide. The additional dielectric material can act as an adhesive layer between two ferromagnetic layers. The additional dielectric material can comprise a polyimide, an epoxy, a polyacrylate, a silicone, a polycyclobutene, or a combination comprising at least one of the foregoing.

One or more plasma zones can also be radially disposed in a position around the drum roll. For example, along the path of travel of the rotating drum roll, a plasma zone can be located upstream of the ferromagnetic zone to result in the dielectric layer first being plasma treated and then being coated with the ferromagnetic material. The plasma treatment can occur at a power density of 0.02 to 0.2 W/cm² and a total pressure of N₂ and Ar of 0.1 to 2 Pa.

The deposition of one or more of the respective layers can be continuous. The deposition of one or more of the respective layers can continuously deposit a layer of a specified thickness. The deposition of one or more of the respective layers can continuously deposit a layer having a thickness that can vary with time, for example, in a step-wise manner. Alternatively, or in addition to, the linear speed of the drum roll can be varied to result in a coating with varied thickness.

An uppermost layer and a lowermost layer of the magneto-dielectric material comprises the dielectric material. For example, the method can comprise first coating the drum roll, optionally with a dummy layer disposed thereon, with only the dielectric material, starting the deposition of the ferromagnetic layer, after a desired number of layers has been achieved, stopping the deposition of the ferromagnetic layer, and then stopping the deposition of the dielectric material.

The magneto-dielectric material formed by drum coating can be removed from the drum roll, optionally formed to a desired size, and then laminated between two dielectric layers to form the uppermost layer and the lowermost layer. The uppermost layer and the lowermost layer can comprise an outer layer dielectric material that is the same or different material as the dielectric layer. Depending on the material, the laminating can occur at a temperature of 150 to 400° C. and a pressure of 0.3 to 9 MPa, 1 to 7 MPa, or 3 to 5 MPa.

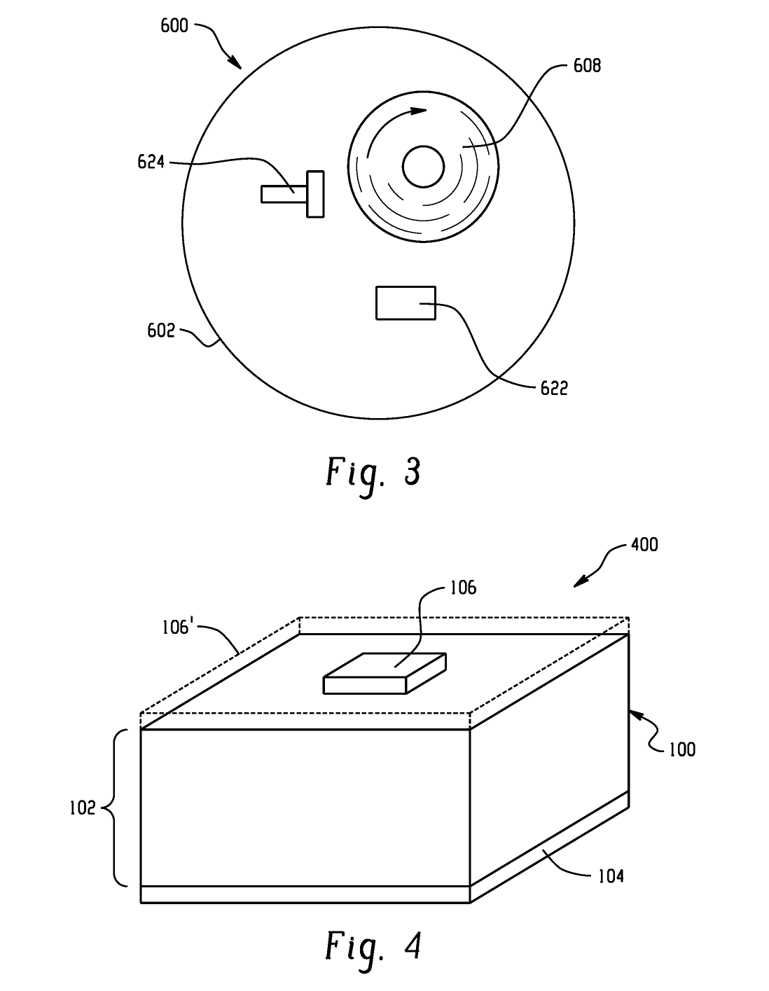

FIG. 3 is an illustrative example of an embodiment of drum roll coater 600. In drum roll coater 600, drum roll 608 rotates in a clockwise direction. Along a path of travel illustrated by the arrow of a location on drum roll 608, the location passes ferromagnetic coating zone 622 and then by dielectric coating zone 624. The entire set-up is located in vacuum chamber 602.

Each ferromagnetic layer independently has a thickness of greater than or equal to 1/15^{th} a skin depth of the respective ferromagnetic material at the defined maximum frequency, and less than or equal to ⅕^{th} the skin depth of the respective ferromagnetic material at the defined maximum frequency. Each ferromagnetic layer independently can have the same thickness. The ferromagnetic layer can have a different thickness than another one of the plurality of ferromagnetic layers. A more centrally disposed ferromagnetic layer of the plurality of ferromagnetic layers can be thicker than a more outwardly disposed ferromagnetic layer, where the term “thicker” can mean thicker by a factor of less than or equal to 2:1 and greater than 1:1. For example, in FIG. 1, centrally disposed ferromagnetic layer 306 can be thicker than outermost ferromagnetic layers 302 and 310 and inner ferromagnetic layers 304 and 308 can each independently be the same or different thickness as centrally disposed ferromagnetic layer 306 or outermost ferromagnetic layers 302 and 310. The thickness of the respective ferromagnetic layers can increase from a centrally disposed ferromagnetic layer to an outermost ferromagnetic layer. For example, in FIG. 1, centrally disposed ferromagnetic layer 306 can be thicker than inner ferromagnetic layers 304 and 308; and inner ferromagnetic layers 304 and 308 can be thicker than outermost ferromagnetic layers 302 and 310.

Each ferromagnetic layer independently can comprise the same or different ferromagnetic material. Each ferromagnetic layer can comprise the same ferromagnetic material. The ferromagnetic material of each ferromagnetic layer independently can have a magnetic permeability of greater than or equal to: (the defined maximum frequency in hertz) divided by (800 times 10̂9). The ferromagnetic material can comprise iron, nickel, cobalt, or a combination comprising at least one of the foregoing. The ferromagnetic material can comprise nickel-iron, iron-cobalt, iron-nitride (Fe₄N), iron-gadolinium, or a combination comprising at least one of the foregoing. Each ferromagnetic layer independently can have a thickness of greater than or equal to 20 nanometers, or 20 to 60 nanometers, or 30 to 50 nanometers, or less than or equal to 200 nanometers, or 100 nanometers to 1 micrometer, or 20 nanometers to 1 micrometer. Each ferromagnetic layer independently can comprise iron-nitride and can have a thickness of 100 to 200 nanometers.

Each dielectric layer independently has a thickness and a dielectric constant sufficient to provide a dielectric withstand voltage across the respective thickness of 150 to 1,500 volts peak, the dielectric withstand voltage (also referred to as highpotential [Hi-Pot], over potential, or voltage breakdown) being tested in accordance with a standard electrical method such as ASTM D 149, see IPC-TM-650 TEST METHODS MANUAL, Number 2.5.6.1, March 2007. Each dielectric layer can have a dielectric constant of less than or equal to 2.8 at the defined maximum frequency. Each dielectric layer independently can comprise a dielectric polymer and can have a dielectric constant of less than or equal to 2.8 at the defined maximum frequency. Each dielectric layer independently can have a dielectric constant of 2.4 to 5.6, with an intrinsic dielectric strength of 100 to 1,000 volts/micrometer. Each dielectric layer independently can comprise a dielectric polymer and a dielectric filler (e.g., silica) and can have a dielectric constant of 2.4 to 5.6. The dielectric material can have a loss tangent (tanδₑ) of less than or equal to 0.005.

Each dielectric layer independently can have the same thickness. The dielectric layers can have different thickness from one another. Each dielectric layer independently can have a thickness of 0.5 to 6 micrometers. Each dielectric layer independently can have a thickness of 0.1 to 10 micrometers. A ratio of the thickness of any one dielectric layer to any one ferromagnetic layer can be 1:1 to 100:1, or 1:1 to 10:1.

The outermost dielectric layers can have an increased thickness as compared to the dielectric layers within the magneto-dielectric material. For example, the outermost dielectric layers can each independently have a thickness of 20 to 1,000 micrometers, or 50 to 500 micrometers, or 100 to 400 micrometers.

Each dielectric layer independently can comprise the same or different dielectric material. Each dielectric layer independently can comprise the same dielectric material. The plurality of dielectric layers can comprise layers of alternating dielectric material. For example, in FIG. 1, layers 202, 206, and 210 can comprise a first dielectric material and layers 204, 208, and 212 can comprise a second dielectric material (for example, the additional dielectric material or the thin film dielectric material) different from the first dielectric material.

The dielectric material, including the additional dielectric material, the thin film dielectric material, and the outer layer dielectric material, can each independently comprise a dielectric polymer, for example, a thermoplastic polymer or a thermoset polymer. The polymer can include oligomers, polymers, ionomers, dendrimers, copolymers (such as graft copolymers, random copolymers, block copolymers (e.g., star block copolymers, random copolymers, etc.)), and combinations comprising at least one of the foregoing. Examples of polymers that can be used include cyclic olefin polymers (including polynorbornenes and copolymers containing norbornenyl units, for example, copolymers of a cyclic polymer such as norbornene and an acyclic olefin such as ethylene or propylene), fluoropolymers (e.g., polyvinyl fluoride (PVF), fluorinated ethylene-propylene (FEP), polytetrafluoroethylene (PTFE), poly(ethylene-tetrafluoroethylene (PETFE), perfluoroalkoxy (PFA)), polyacetals (e.g., polyoxyethylene and polyoxymethylene), poly(C₁₋₆ alkyl)acrylates, polyacrylonitriles, polyanhydrides, polyarylene ethers (e.g., polyphenylene ethers), poly(ether ketones) (e.g., polyether ether ketone (PEEK) and polyether ketone ketone (PEKK)), polyarylene ketones, polyarylene sulfones (e.g., polyethersulfones (PES), polyphenylene sulfones (PPS), and the like), polybenzothiazoles, polybenzoxazoles, polybenzimidazoles, polycarbonates (including homopolycarbonates and polycarbonate copolymers such as polycarbonate-esters), polyesters (e.g., polyethylene terephthalates, polybutylene terephthalates, polyarylates, and polyester copolymers such as polyester-ethers), polyetherimides, polyimides, poly(C₁₋₆ alkyl)methacrylates, polymethacrylamides (including unsubstituted and mono-N- and di-N-(C₁₋₈ alkyl)acrylamides), polyolefins (e.g., polyethylenes, such as high density polyethylene (HDPE), low density polyethylene (LDPE), and linear low density polyethylene (LLDPE), polypropylenes, and their halogenated derivatives (such as polytetrafluoroethylenes(PTFE)), and their copolymers, for example, ethylene-alpha-olefin copolymers, polyoxadiazoles, polyoxymethylenes, polyphthalides, polysilazanes, polystyrenes (including copolymers such as acrylonitrile-butadiene-styrene (ABS) and methyl methacrylate-butadiene-styrene (MBS)), polysulfonamides, polysulfonates, polysulfones, polythioesters, polytriazines, polyureas, polyurethanes, vinyl polymers (including polyvinyl alcohols, polyvinyl esters, polyvinyl ethers, polyvinyl halides (e.g., polyvinyl fluoride), polyvinyl ketones, polyvinyl nitriles, polyvinyl thioethers, and polyvinylidene fluorides), alkyds, bismaleimide polymers, bismaleimide triazine polymers, cyanate ester polymers, benzocyclobutene polymers, diallyl phthalate polymers, epoxies, hydroxymethylfuran polymers, melamine-formaldehyde polymers, benzoxazines, polydienes such as polybutadienes (including homopolymers and copolymers thereof, e.g., poly(butadiene-isoprene)), polyisocyanates, polyureas, polyurethanes, triallyl cyanurate polymers, triallyl isocyanurate polymers, and polymerizable prepolymers (e.g., prepolymers having ethylenic unsaturation, such as unsaturated polyesters, polyimides), or the like.

The dielectric material including the additional dielectric material, the thin film dielectric material, and the outer layer dielectric material, can each independently comprise can comprise a polyolefin (such as a polypropylene or polyethylene); a cyclic olefin copolymer such as a TOPAS olefin polymer commercially available from TOPAS Advance Polymers, Frankfurt-Hoechst, Germany; a polyester (such as poly(ethylene terephthalate)); a polyetherketone (such as polyether ether ketone); or a combination comprising at least one of the foregoing. The dielectric material can comprise PTFE, expanded PTFE, FEP, PFA, ETFE, (polyethylene-tetrafluoroethylene), a fluorinated polyimide, or a combination comprising at least one of the foregoing. The dielectric material can comprise a polyimide having an oligomeric or polymeric silsesquioxane group attached to the polyimide. The oligomeric or polymeric silsesquioxane group can be a polyhedral oligomeric silsesquioxane group (POSS). In an embodiment, the polyimide forms a polymer backbone, and the oligomeric or polymeric silsesquioxane group is attached to the polymer backbone through a tether, for example, a carboxylic group. In an embodiment, the oligomeric or polymeric silsesquioxane group is not a part of the repeating polymer backbone. Polysilsesquioxane-derivatized polyimides can be prepared by many methods, including those provided in U.S. Pat. No. 7,619,042. In an embodiment, an oligomeric or polymeric silsesquioxane group can be attached to a polyimide by a carboxylic attachment point. Such materials are commercially available from, for example, NeXolve Corporation, Huntsville, Ala.

At least one dielectric layer can comprise a fluorinated polyimide with a dielectric constant of 2.4 to 2.6, with a thickness of 0.1 to 4.7 micrometers.

The dielectric material, including the additional dielectric material, the thin film dielectric material, and the outer layer dielectric material, can each independently comprise one or more dielectric fillers to adjust the properties thereof (e.g., dielectric constant or coefficient of thermal expansion). The dielectric filler can comprise titanium dioxide (such as rutile or anatase), barium titanate, strontium titanate, silica (for example, fused amorphous silica or fumed silica), corundum, wollastonite, boron nitride, hollow glass microspheres, or a combination comprising at least one of the foregoing.

The dielectric material, including the additional dielectric material, the thin film dielectric material, and the outer layer dielectric material, can each independently comprise a ceramic. For example, use of a ceramic in place of a polymer could be in accordance with the following: the thickness of the ceramic relative to the thickness of a suitable polymer in accordance with an embodiment disclosed herein would be adjusted such that the ratio (given ceramic dielectric constant)/(suitable polymer dielectric constant) is equal to the ratio (suitable polymer thickness)/(given ceramic thickness). The ceramic can comprise silicon dioxide (SiO₂) (such as amorphous SiO₂), alumina, aluminum nitride, silicon nitride, or a combination comprising at least one of the foregoing. The thickness of the ceramic layer, for example, comprising silicon dioxide, can be less than or equal to [2.1/(εᵣ of the ceramic)×(8 micrometers)], and can have a minimum dielectric strength of 150 volts peak.

Each dielectric layer can comprise two or more dielectric materials that are different from each other. For example, a given dielectric layer can comprise a first dielectric material and a second dielectric material, each with different dielectric constants and either the same thickness or different thicknesses. The first dielectric material can comprise a fluorinated polyimide and the second dielectric material can comprise PTFE or expanded PTFE, PEEK, or PFA. The first dielectric material can comprise a polymer having a low melting temperature (for example, polypropylene and poly(ethylene terephthalate)) and the second dielectric material can comprise a fluoropolymer (for example, PTFE). The first dielectric material can comprise a ceramic and the second dielectric material is either a ceramic or a non-ceramic dielectric material. The first dielectric material can provide a substrate for deposition thereon of one of the plurality of the ferromagnetic material layers, and the second dielectric material can provide an additional dielectric layer for control of the substrate refractive index. The first dielectric material and the second dielectric material can be separated by a ferromagnetic layer. The plurality of dielectric layers can comprise alternating layers of a first dielectric material layer and a second dielectric material layer wherein each of the first dielectric material layer and the second dielectric material layer are separated by a ferromagnetic layer.

A conductive layer can be located on one or both of the uppermost dielectric layer and the lowermost dielectric layer. The conductive layer can comprise copper. The conductive layer can have a thickness of 3 to 200 micrometers, or 9 to 180 micrometers. Suitable conductive layers include a thin layer of a conductive metal such as a copper foil presently used in the formation of circuits, for example, electrodeposited copper foils. The copper foil can have a root mean squared (RMS) roughness of less than or equal to 2 micrometers, or less than or equal to 0.7 micrometers, where roughness is measured using a Veeco Instruments WYCO Optical Profiler, using the method of white light interferometry.

The conductive layer can be applied by placing the conductive layer in the mold prior to molding, by laminating the conductive layer onto the magneto-dielectric material, by direct laser structuring, or by adhering the conductive layer to the substrate via an adhesive layer. For example, a laminated substrate can comprise an optional polyfluorocarbon film that can be located in between the conductive layer and the magneto-dielectric material, and a layer of microglass reinforced fluorocarbon polymer that can be located in between the polyfluorocarbon film and the conductive layer. The layer of microglass reinforced fluorocarbon polymer can increase the adhesion of the conductive layer to the magneto-dielectric material. The microglass can be present in an amount of 4 to 30 wt % based on the total weight of the layer. The microglass can have a longest length scale of less than or equal to 900 micrometers, or less than or equal to 500 micrometers. The microglass can be microglass of the type as commercially available by Johns-Manville Corporation of Denver, Colo. The polyfluorocarbon film comprises a fluoropolymer (such as polytetrafluoroethylene (PTFE), a fluorinated ethylene-propylene copolymer (such as TEFLON FEP), and a copolymer having a tetrafluoroethylene backbone with a fully fluorinated alkoxy side chain (such as TEFLON PFA)).

The conductive layer can be applied by laser direct structuring. Here, the magneto-dielectric material can comprise a laser direct structuring additive, where a laser is used to irradiate the surface of the substrate, forming a track of the laser direct structuring additive, and a conductive metal is applied to the track. The laser direct structuring additive can comprise a metal oxide particle (such as titanium oxide and copper chromium oxide). The laser direct structuring additive can comprise a spinel-based inorganic metal oxide particle, such as spinel copper. The metal oxide particle can be coated, for example, with a composition comprising tin and antimony (for example, 50 to 99 weight percent (wt %) of tin and 1 to 50 wt % of antimony, based on the total weight of the coating). The laser direct structuring additive can comprise 2 to 20 parts of the additive based on 100 parts of the respective composition. The irradiating can be performed with a YAG laser having a wavelength of 1,064 nm under an output power of 10 Watts, a frequency of 80 kilohertz, and a rate of 3 meters per second. The conductive metal can be applied using a plating process in an electroless plating bath comprising, for example, copper.

Alternatively, the conductive layer can be applied by adhesively applying the conductive layer. In an embodiment, the conductive layer is the circuit (the metallized layer of another circuit), for example, a flex circuit. For example, an adhesion layer can be disposed between one or both of the conductive layer(s) and the substrate. The adhesion layer can comprise a poly(arylene ether); and a carboxy-functionalized polybutadiene or polyisoprene polymer comprising butadiene, isoprene, or butadiene and isoprene units, and zero to less than or equal to 50 wt % of co-curable monomer units; wherein the composition of the adhesive layer is not the same as the composition of the substrate layer. The adhesive layer can be present in an amount of 2 to 15 grams per square meter. The poly(arylene ether) can comprise a carboxy-functionalized poly(arylene ether). The poly(arylene ether) can be the reaction product of a poly(arylene ether) and a cyclic anhydride, or the reaction product of a poly(arylene ether) and maleic anhydride. The carboxy-functionalized polybutadiene or polyisoprene polymer can be a carboxy-functionalized butadiene-styrene copolymer. The carboxy-functionalized polybutadiene or polyisoprene polymer can be the reaction product of a polybutadiene or polyisoprene polymer and a cyclic anhydride. The carboxy-functionalized polybutadiene or polyisoprene polymer can be a maleinized polybutadiene-styrene or maleinized polyisoprene-styrene copolymer. Other methods known in the art can be used to apply the conductive layer where admitted by the particular materials and form of the circuit material, for example, electrodeposition, chemical vapor deposition, lamination, or the like.

The conductive layer can be a patterned conductive layer. The magneto-dielectric material can comprise a first conductive layer and a second conductive layer located on opposite sides of the magneto-dielectric material.

An apparatus can comprise the magneto-dielectric material. An example application for the apparatus is for use in a dipole antenna where the magneto-dielectric material is used to form a magneto-dielectric cavity loading element that enables the antenna to be placed dramatically less than ¼ wavelength, in free space, from a metallic ground plane with little to no degradation in bandwidth. Such an application finds utility in aircraft antennas, where the magneto-dielectric material enables the use of low profile antennas having dramatically reduced drag when disposed on an external skin of the aircraft as compared to existing aircraft antenna systems. Other example applications include systems where multiple antenna elements must be co-located in an environment demanding of a small form factor antenna.

With reference now to FIG. 4, an example apparatus 400 for use with the magneto-dielectric material 100 is depicted having a first conductive layer 104 disposed in conforming direct contact with the lowermost dielectric layer of the plurality of layers 102, and a second conductive layer 106 disposed in conforming direct contact with the uppermost dielectric layer of the plurality of layers 102. The first conductive layer 104 can define a ground plane and the second conductive layer 106 can define a patch suitable for use in a patch antenna. The first and second conductive layers 104, 106 can be copper cladded layers. The apparatus 400 can be in the form of a multilayer sheet where each of the plurality of layers 102 and the first and second conductive layers 104, 106′ (depicted in dotted line fashion) have the same plane view dimensions. While FIG. 4 depicts apparatus 400, such as a single patch antenna, it will be appreciated that the scope of the disclosure is not so limited and also encompasses a plurality of apparatuses (such as a plurality of patch antennas) arranged in an array to form a multi-layer magneto-dielectric thin film antenna array.

As used herein the term conforming direct contact means that each layer of the herein described layers is in direct physical contact with its respective adjacent layer or layers and conforms to the respective surface profile or profiles of the respective adjacent layer or layers so as to form a magneto-dielectric material that is substantially absent any voids at an interface between a pair of adjacent layers.

The following examples are provided to illustrate methods of forming the magneto-dielectric material. The examples are merely illustrative and are not intended to limit method or material made in accordance with the disclosure to the materials, conditions, or process parameters set forth therein.

### EXAMPLES

### Example 1

### Roll Coating a Ferromagnetic Layer onto one Side of a Dielectric Substrate

A ferromagnetic iron nitride layer is roll coated onto one side of a PTFE or PEEK substrate to form a coated sheet. The PTFE substrate, such as those commercially available from DeWal or Saint Gobain, has a thickness of 8 micrometers and the PEEK substrate, such as those commercially available from Vitrex, has a thickness of 6 micrometers. The substrate proceeds through a ferromagnetic coating zone at a linear speed of 150 to 600 cm/min The ferromagnetic coating zone is at an iron target of 1 to 100 watts per centimeter squared (W/cm²) power density, a base pressure of 1×10 to 1×10⁻⁵ Pascal (Pa), and a total pressure (P_{N2}/(P_{N2}+P_{Ar})=0.01 to 0.2) of 0.1 to 2 Pa. Upstream of the ferromagnetic coating zone, the substrate can be plasma treated to increase the adhesion of the iron nitride and the substrate. The plasma treatment can occur at a power density of 0.02 to 0.3 W/cm² and a total pressure of N₂ and Ar of 0.1 to 2 Pa.

The coated sheet is then cut into a plurality of sheets having the same width and length, for example, of 2 feet by 4 feet. A multilayer stack of the plurality of sheets is formed such that all of the ferromagnetic layers face in the same direction and a dielectric layer is placed on the outermost ferromagnetic layer and the multilayer stack is laminated to form the magneto-dielectric material. The laminating occurs at a temperature of 150 to 400° C. and a pressure of 0.3 to 9 MPa.

The resulting magneto-dielectric material has alternating iron nitride ferromagnetic layers and dielectric layers, where each of the dielectric layers comprise the same material and have the same thickness and where each of the ferromagnetic layers comprise the same material and have the same thickness.

### Example 2

### Roll Coating a Ferromagnetic Layer Onto Two Sides of a Dielectric Substrate

The process of Example 1 is followed except that the ferromagnetic coating zone is located on both sides of the dielectric layer and a dielectric coating zone is located downstream of the ferromagnetic coating zone also on both sides of the dielectric layer. In the dielectric coating zone, a 1 to 2 micrometer thick curable composition (such as a curable polyimide composition, a curable epoxy composition, a curable acrylate composition, a curable siloxane composition, and a curable cyclobutene composition) is spray coated onto the ferromagnetic layer and the curable polyimide composition is cured at a temperature of 160° C. and a pressure of 0.01 to 0.1 Pa.

The resulting magneto-dielectric material has alternating iron nitride ferromagnetic layers and dielectric layers, where every other dielectric layer alternates between a substrate layer and a layer derived from the cured composition.

### Example 3

### Roll Coating a Ferromagnetic Layer Onto Two Sides of a Dielectric Substrate and Laminating with Alternating Dielectric Thin Films

The process of Example 2 is followed except that when forming the multilayer stack, a thin film is added between each of the plurality of cut sheets. The thin film comprises, for example, a polyester such as polyethylene terephthalate (such as those commercially available from Toray or Teijin Dupont) or a polyolefin such as polyethylene or polypropylene. The thin film has a thickness of 2 to 4 micrometers. The substrate is a 12 micrometer thick PTFE film or an 8 micrometer thick PEEK film. The laminating occurs at a temperature of 150 to 400° C. and at a pressure of 0.3 to 9 MPa.

The resulting magneto-dielectric material has alternating iron nitride ferromagnetic layers and dielectric layers, where every other dielectric layer alternates between a substrate layer and a thin film layer.

### Example 4

### Drum Roll Coating of Alternating Ferromagnetic and Dielectric Layers

Alternating ferromagnetic and dielectric layers are deposited on a dielectric substrate disposed on a rotating drum to form a magneto-dielectric material, where a ferromagnetic material deposition location and a dielectric material deposition location are located radially in a position around the drum. The ferromagnetic material deposition location deposits iron nitride using the conditions as described in Example 1. The dielectric material deposition location deposits a dielectric material such as PTFE or amorphous SiO₂. The rotating drum rotates at a linear speed of 30 to 120 cm/min.

### Example 5

### Drum Roll Coating and Laminating the Layered Stack

Several multilayers are prepared according to Example 4. The multilayers are layered to form a layered stack and the layered stack is then laminated to form the magneto-dielectric materials.

When the dielectric material deposition location deposits PTFE, the PTFE can be deposited by RF sputtering with a PTFE target of 1 to 100 W/cm² power density, a base pressure of −5 to −7 Pa, and a total pressure (P_{CF4}/(P_{CF4}+P_{Ar})=0 to 0.2) of 0.1 to 2 Pa.

When the dielectric material deposition location deposits SiO₂, the SiO₂ can be deposited by DC sputtering with an Si target of 1 to 100 W/cm² power density, a base pressure of 1×10 to 1×10⁻⁵ Pa, and a total pressure (P_{O2}/(P_{O2}+P_{Ar})=0.1 to 0.3) of 0.1 to 2 Pa. Conversely, the SiO₂ can be deposited by PECVD with a 0.1 to 10 W/cm² power density and a total pressure (P_{TEOS}/(P_{TEOS}+P_{O2})=0.005 to 0.05) of 50 to 200 Pa.

A plasma treatment location can also be located radially in a position around the rotating drum such that the exposed layer can be plasma treated to increase the adhesion of the exposed layer to the subsequently added layer. The plasma treatment can occur at a power density of 0.02 to 0.2 W/cm² and a total pressure of N₂ and Ar of 0.1 to 2 Pa.

The resulting magneto-dielectric material has alternating iron nitride ferromagnetic layers and dielectric layers.

The magneto-dielectric material can then be layered in between two dielectric layers of PTFE or PEEK, each independently having a thickness of 100 to 400 micrometers, and laminated at a temperature of 150 to 400° C. and a pressure of 0.3 to 9 MPa.

The above method of forming the magneto-dielectric material is further described in the below embodiments.

Embodiment 1: A method of forming a magneto-dielectric material, the method comprising: roll coating a ferromagnetic material onto a dielectric layer comprising a dielectric material by continuously moving the dielectric layer through a ferromagnetic coating zone to form a coated sheet comprising a ferromagnetic layer disposed on the dielectric layer, wherein the dielectric layer travels a path from a first roll through the ferromagnetic coating zone to a second roll; forming a plurality of sheets from the coated sheet; forming a layered stack of the plurality of sheets; laminating the layered stack to form the magneto-dielectric material having a plurality of alternating ferromagnetic layers and dielectric layers, wherein an uppermost layer and a lowermost layer comprise an outer layer dielectric material; wherein the magneto-dielectric material is operable over an operating frequency range equal to or greater than a defined minimum frequency and equal to or less than a defined maximum frequency; wherein each layer of the plurality of ferromagnetic layers has a ferromagnetic layer thickness of 1/15^{th} to ⅕^{th} the skin depth of the respective ferromagnetic layer at the defined maximum frequency; wherein each layer of the plurality of dielectric material layers has a dielectric layer thickness and a dielectric constant that provides a dielectric withstand voltage across the respective thickness of 150 to 1,500 volts peak; and wherein the plurality of layers has an overall thickness of less than or equal to one wavelength of the defined minimum frequency in the plurality of layers.

Embodiment 2: The method of Embodiment 1, wherein the ferromagnetic coating zone is located on both sides of the dielectric layer.

Embodiment 3: The method of any one or more of the preceding embodiments, wherein each of the plurality of sheets in the layered stack has the ferromagnetic layer pointed in a same direction with respect to the dielectric layer.

Embodiment 4: The method of Embodiment 1, wherein alternating sheets of the plurality of sheets in the layered stack has the ferromagnetic layer pointed in an opposite direction with respect to the dielectric layer.

Embodiment 5: The method of any one or more of the preceding embodiments, further comprising coating an additional dielectric material onto the ferromagnetic layer in a dielectric coating zone located downstream of the ferromagnetic coating zone.

Embodiment 6: The method of Embodiment 5, wherein the additional dielectric material and the dielectric material are different.

Embodiment 7: The method of any one or more of Embodiments 5 to 6, wherein the additional dielectric material comprises a ceramic.

Embodiment 8: The method of any one or more of Embodiments 5 to 6, wherein the additional dielectric material comprises a curable composition.

Embodiment 9: The method of any one or more of Embodiments 5 to 8, wherein the coating the additional dielectric material comprises roll over knife coating or reverse coating.

Embodiment 10: The method of any one or more of Embodiments 5, 6, 8, or 9, wherein the coating the additional dielectric material comprises spray coating, evaporation, chemical vapor deposition, roll over knife coating, reverse roll coating, or sputtering.

Embodiment 11: The method of any one or more of Embodiments 5 to 10, wherein the magneto-dielectric material comprises alternating layers of the dielectric material and the deposited dielectric material with the ferromagnetic layers disposed between the dielectric layers and the deposited dielectric layers.

Embodiment 12: The method of any one or more of the preceding embodiments, wherein the layered stack further comprises a plurality of thin dielectric films comprising a thin film dielectric material located between layers of the plurality of sheets.

Embodiment 13: The method of Embodiment 12, wherein magneto-dielectric material comprises alternating layers of the dielectric material and the thin film dielectric material with the ferromagnetic layers disposed between each of the dielectric layers and thin film dielectric layers derived from the plurality of thin dielectric films.

Embodiment 14: The method of any one or more of Embodiments 12 to 13, wherein the thin film dielectric material comprises a polyester, a polyolefin, or a combination comprising at least one of the foregoing.

Embodiment 15: A method of forming a magneto-dielectric material, the method comprising: drum roll coating a ferromagnetic material and a dielectric material onto a drum roll, wherein a ferromagnetic coating zone and a dielectric coating zone are disposed radially in a position around the drum roll, and wherein the ferromagnetic coating zone deposits the ferromagnetic material and the dielectric coating zone deposits the dielectric material to form the magneto-dielectric material having a plurality of alternating ferromagnetic layers and dielectric layers; wherein an uppermost layer and a lowermost layer of the magneto-dielectric material comprise an outer layer dielectric material; wherein the magneto-dielectric material is operable over an operating frequency range equal to or greater than a defined minimum frequency and equal to or less than a defined maximum frequency; wherein each layer of the plurality of ferromagnetic layers has a ferromagnetic layer thickness of 1/15^{th} to ⅕^{th} the skin depth of the respective ferromagnetic layer at the defined maximum frequency; wherein each layer of the plurality of dielectric material layers has a dielectric layer thickness and a dielectric constant that provides a dielectric withstand voltage across the respective thickness of 150 to 1,500 volts peak; and wherein the plurality of layers has an overall thickness of less than or equal to one wavelength of the defined minimum frequency in the plurality of layers.

Embodiment 16: The method of Embodiment 15, comprising depositing an additional ferromagnetic material in an additional ferromagnetic coating zone and an additional dielectric material in an additional dielectric material coating zone; wherein a path of travel of a location on the drum roll comprises passing sequentially through the dielectric coating zone, the ferromagnetic coating zone, the additional dielectric coating zone, and the additional ferromagnetic coating zone.

Embodiment 17: The method of Embodiment 16, wherein the ferromagnetic material and the additional ferromagnetic material are the same.

Embodiment 18: The method of any one or more of Embodiments 16 to 17, wherein the dielectric material and the additional dielectric material are different.

Embodiment 19: The method of any one or more of Embodiments 15 to 18, further comprising first coating the drum roll with only the dielectric material, starting the deposition of the ferromagnetic layer, after a desired number of layers has been deposited, stopping the deposition of the ferromagnetic layer, and then stopping the deposition of the dielectric material.

Embodiment 20: The method of any one or more of Embodiments 5 to 11 or 16 to 19, wherein the additional dielectric material comprises an epoxy, a polyacrylate, a silicone, a polycyclobutene, a polyimide, or a combination comprising at least one of the foregoing.

Embodiment 21: The method of any one or more of the preceding embodiments, wherein the ferromagnetic material comprises iron, nickel, cobalt, gadolinium, or a combination comprising at least one of the foregoing.

Embodiment 22: The method of any one or more of the preceding embodiments, wherein the dielectric material comprises a fluoropolymer, a poly(ether ketone), a polyimide, a polyolefin, a polyester, or a combination comprising at least one of the foregoing.

Embodiment 23: The method of any one or more of the preceding embodiments, wherein the dielectric material comprises a fluorinated polymer or a poly(ether ketone).

Embodiment 24: The method of any one or more of the preceding embodiments, further comprising plasma treating the dielectric layer in a plasma zone located upstream of the ferromagnetic coating zone.

Embodiment 25: The method of any one or more of the preceding embodiments, comprising laminating the magneto-dielectric material between two dielectric layers to form the uppermost layer and the lowermost layer.

Embodiment 26: The method of any one or more of the preceding embodiments, wherein the ferromagnetic layer thickness is 20 nanometers to 1 micrometer.

Embodiment 27: The method of any one or more of the preceding embodiments, wherein the dielectric layer thickness is 0.1 to 50 micrometers.

Embodiment 28: The method of any one or more of the preceding embodiments, wherein the magneto-dielectric material has an overall thickness of 0.1 to 3 mm.

Embodiment 29: An article made by any one or more of the preceding embodiments.

In general, the disclosure can alternately comprise, consist of, or consist essentially of, any appropriate components herein disclosed. The disclosure can additionally, or alternatively, be formulated so as to be devoid, or substantially free, of any components, materials, ingredients, adjuvants or species used in the prior art compositions or that are otherwise not necessary to the achievement of the function and/or objectives of the present disclosure.

The terms “a” and “an” do not denote a limitation of quantity, but rather denote the presence of at least one of the referenced item. The term “or” means “and/or” unless clearly indicated otherwise by context. “Optional” or “optionally” means that the subsequently described event or circumstance may or may not occur, and that the description includes instances where the event occurs and instances where it does not.

As used herein, the term “dielectric constant” is also known as the relative permittivity. The dielectric constant can be determined at the operating frequency, for example, at 100 MHz to 10 GHz, or 1 to 10 GHz, or 100 MHz to 5 GHz. The dielectric constant can be determined at 23° C.

Reference throughout the specification to “an embodiment”, “another embodiment”, “some embodiments”, and so forth, means that a particular element (e.g., feature, structure, step, or characteristic) described in connection with the embodiment is included in at least one embodiment described herein, and may or may not be present in other embodiments. In addition, it is to be understood that the described elements may be combined in any suitable manner in the various embodiments.

In general, the compositions, methods, and articles can alternatively comprise, consist of, or consist essentially of, any ingredients, steps, or components herein disclosed. The compositions, methods, and articles can additionally, or alternatively, be formulated, conducted, or manufactured so as to be devoid, or substantially free, of any ingredients, steps, or components not necessary to the achievement of the function or objectives of the present claims.

Unless specified to the contrary herein, all test standards are the most recent standard in effect as of the filing date of this application, or, if priority is claimed, the filing date of the earliest priority application in which the test standard appears.

The endpoints of all ranges directed to the same component or property are inclusive of the endpoints, are independently combinable, and include all intermediate points and ranges. For example, ranges of “up to 25 wt %, or more specifically, 5 to 20 wt %” is inclusive of the endpoints and all intermediate values of the ranges of “5 to 25 wt %,” such as 10 to 23 wt %, etc.).

The terms “first,” “second,” and the like, “primary,” “secondary,” and the like, as used herein do not denote any order, quantity, or importance, but rather are used to distinguish one element from another. The terms “upper”, “lower”, “bottom”, and/or “top” are used herein, unless otherwise noted, merely for convenience of description, and are not limited to any one position or spatial orientation. The term “combination” is inclusive of blends, mixtures, alloys, reaction products, and the like.

Unless defined otherwise, technical and scientific terms used herein have the same meaning as is commonly understood by one of skill in the art to which this disclosure belongs.

All cited patents, patent applications, and other references are incorporated herein by reference in their entirety. However, if a term in the present application contradicts or conflicts with a term in the incorporated reference, the term from the present application takes precedence over the conflicting term from the incorporated reference.

While particular embodiments have been described, alternatives, modifications, variations, improvements, and substantial equivalents that are or may be presently unforeseen may arise to applicants or others skilled in the art. Accordingly, the appended claims as filed and as they may be amended are intended to embrace all such alternatives, modifications variations, improvements, and substantial equivalents.

What is claimed is:

1. A method of forming a magneto-dielectric material, the method comprising:
roll coating a ferromagnetic material onto a dielectric layer comprising a dielectric material by continuously moving the dielectric layer through a ferromagnetic coating zone to form a coated sheet comprising a ferromagnetic layer disposed on the dielectric layer, wherein the dielectric layer travels a path from a first roll through the ferromagnetic coating zone to a second roll;
forming a plurality of sheets from the coated sheet;
forming a layered stack of the plurality of sheets;
laminating the layered stack to form the magneto-dielectric material having a plurality of alternating ferromagnetic layers and dielectric layers, wherein an uppermost layer and a lowermost layer comprise an outer layer dielectric material;
wherein the magneto-dielectric material is operable over an operating frequency range equal to or greater than a defined minimum frequency and equal to or less than a defined maximum frequency;
wherein each layer of the plurality of ferromagnetic layers has a ferromagnetic layer thickness of 1/15^{th} to ⅕^{th} the skin depth of the respective ferromagnetic layer at the defined maximum frequency;
wherein each layer of the plurality of dielectric material layers has a dielectric layer thickness and a dielectric constant that provides a dielectric withstand voltage across the respective thickness of 150 to 1,500 volts peak; and
wherein the plurality of layers has an overall thickness of less than or equal to one wavelength of the defined minimum frequency in the plurality of layers.

2. The method of claim 1, wherein the ferromagnetic coating zone is located on both sides of the dielectric layer.

3. The method of claim 1, wherein the ferromagnetic material comprises iron, nickel, cobalt, gadolinium, or a combination comprising at least one of the foregoing.

4. The method of claim 1, wherein the dielectric material comprises a fluoropolymer, a poly(ether ketone), a polyimide, a polyolefin, a polyester, or a combination comprising at least one of the foregoing.

5. The method of claim 1, wherein one or more of the ferromagnetic layer thickness is 20 nanometers to 1 micrometer, the dielectric layer thickness is 0.1 to 50 micrometers, and the magneto-dielectric material has an overall thickness of 0.1 to 3 mm

6. The method of claim 1, comprising laminating the magneto-dielectric material between two dielectric layers to form the uppermost layer and the lowermost layer.

7. The method of claim 1, further comprising coating an additional dielectric material onto the ferromagnetic layer in a dielectric coating zone located downstream of the ferromagnetic coating zone.

8. The method of claim 7, wherein the additional dielectric material comprises a a fluoropolymer, a poly(ether ketone), a polyimide, a polyolefin, a polyester, a ceramic, or a combination comprising at least one of the foregoing.

9. The method of claim 1, wherein the layered stack further comprises a plurality of thin dielectric films comprising a thin film dielectric material located between layers of the plurality of sheets.

10. The method of claim 9, wherein the thin film dielectric material comprises a polyester, a polyolefin, or a combination comprising at least one of the foregoing.

11. The method of claim 1, further comprising plasma treating the dielectric layer in a plasma zone located upstream of the ferromagnetic coating zone.

12. A method of forming a magneto-dielectric material, the method comprising:
drum roll coating a ferromagnetic material and a dielectric material onto a drum roll, wherein a ferromagnetic coating zone and a dielectric coating zone are disposed radially in a position around the drum roll, and wherein the ferromagnetic coating zone deposits the ferromagnetic material and the dielectric coating zone deposits the dielectric material to form the magneto-dielectric material having a plurality of alternating ferromagnetic layers and dielectric layers;
wherein an uppermost layer and a lowermost layer of the magneto-dielectric material comprise an outer layer dielectric material;
wherein the magneto-dielectric material is operable over an operating frequency range equal to or greater than a defined minimum frequency and equal to or less than a defined maximum frequency;
wherein each layer of the plurality of ferromagnetic layers has a ferromagnetic layer thickness of 1/15^{th} to ⅕^{th} the skin depth of the respective ferromagnetic layer at the defined maximum frequency;
wherein each layer of the plurality of dielectric material layers has a dielectric layer thickness and a dielectric constant that provides a dielectric withstand voltage across the respective thickness of 150 to 1,500 volts peak; and
wherein the plurality of layers has an overall thickness of less than or equal to one wavelength of the defined minimum frequency in the plurality of layers.

13. The method of claim 12, comprising depositing an additional ferromagnetic material in an additional ferromagnetic coating zone and an additional dielectric material in an additional dielectric material coating zone; wherein a path of travel of a location on the drum roll comprises passing sequentially through the dielectric coating zone, the ferromagnetic coating zone, the additional dielectric coating zone, and the additional ferromagnetic coating zone.

14. The method of claim 13, wherein the ferromagnetic material and the additional ferromagnetic material are the same.

15. The method of claim 13, wherein the dielectric material and the additional dielectric material are different.

16. The method of claim 13, wherein the additional dielectric material comprises a curable composition or a ceramic.

17. The method of claim 12, further comprising first coating the drum roll with only the dielectric material, starting the deposition of the ferromagnetic layer, after a desired number of layers has been deposited, stopping the deposition of the ferromagnetic layer, and then stopping the deposition of the dielectric material.

18. The method of claim 12, wherein the ferromagnetic material comprises iron, nickel, cobalt, gadolinium, or a combination comprising at least one of the foregoing.

19. The method of claim 12, wherein the dielectric material comprises a fluoropolymer, a poly(ether ketone), a polyimide, a polyolefin, a polyester, or a combination comprising at least one of the foregoing.

20. The method of claim 12, further comprising plasma treating the dielectric layer in a plasma zone located upstream of the ferromagnetic coating zone.
